(19) United States
(12) Patent Application Publication
(10) Pub. No.: US 2014/0172204 A1
(43) Pub. Date: Jun. 19, 2014

(54) METHOD AND DEVICE FOR SUPPLYING DATA RELATING TO A FLIGHT PLAN ON A HUMAN-MACHINE INTERFACE

(71) Applicant: THALES, NEUILLY SUR SEINE (FR)

(72) Inventors: Francois COULMEAU, SEILH (FR); Guy DEKER, CUGNAUX (FR); Patrick MAZOYER, SAINT LEON (FR)

(21) Appl. No.: 14/105,012

(22) Filed: Dec. 12, 2013

(30) Foreign Application Priority Data
Dec. 14, 2012 (FR) 12 03405

(51) Int. Cl. B64D 45/00; G08G 5/00

(52) U.S. Cl. CPC B64D 45/00; G08G 5/0039
USPC 701/14

(57) ABSTRACT

A method and a device is provided for supplying, in summary fashion on a single page of a screen for each point, the data relating to a flight plan. The method makes it possible to establish relevant groups of information according to the situation of the flight and to summarize the display of the data in folded-up mode or in an unfolded lateral mode. The unfolded display offers, on one and the same page, a more precise detail of the situation, by ergonomically and intuitively showing in the columns the predictions in relation to a type of constraint.

### CROSS-REFERENCE TO RELATED APPLICATION

This application claims priority to foreign French patent application No. FR 1203405, filed on Dec. 14, 2012, the disclosure of which is incorporated by reference in its entirety.

### FIELD OF THE INVENTION

The invention relates to the field of embedded systems, in particular the flight management aid systems.

### BACKGROUND

In the field of piloting aids, whether it concerns flight management systems, commonly referred to by the acronym FMS, airport navigations, commonly designated “Onboard Airport Navigation System (OANS), or simply ANS”, or even the mission preparation systems commonly called “Electronic Flight Bag (EFB)”, there is the need to display a large number of information items and of a variety of data relating to the flight plans.

The data are input upstream during the preparation of a flight for example, or during said flight, via a human-machine interface (IHM) of the FMS system. The information that is input or the information that is computed for the flight plan may require the use of several screens to display it a posteriori, corresponding to as many different waypoints.

The technical navigating crews of modern aeroplanes are made up of two people, one on each side of the flight deck: a “captain” side and a “first officer” side. Each one views, on his or her IHMs, on the one hand the graphic navigation screen, and on the other hand the flight data input and verification interface. Notably, he or she views the “flight plan” (PDV) pages that he or she needs according to the assigned task and displaying a finite list of points of the flight plan, a list that may be a pop-up list or displayed in parts when the flight plan exceeds the display size on the interface, with its constraints and predictions at each point. Apart from any particular need to update or view detailed data, the mission is followed essentially through two pages out of the hundred or so available in the latest generation of FMS systems. Now, in this environment, there are constraints which result from the limitation of the number of screens that can be incorporated in the compartment, from the limitation of the number of pages that can be displayed at the same time on one screen, from the need for a captain or first officer to remain as often as possible on one page during the execution of a mission, and from the inability to insert a time, altitude or speed constraint on a waypoint without losing sight of the other constraints and predictions of the same nature.

In practice, a crew has to monitor many items of information on waypoints and procedures such as:

the distance in relation to a preceding element

the aeroplane route angle to arrive at the point

the altitude

the speed

the fuel level

the time of passage

the estimated wind

and other items of information such as:

the quality of the GPS signal at the point,

the temperature,

the navigation requirement,

the min and max time limits achievable,

the time/speed/altitude constraints.

Now, the size of the cockpit screens and the character legibility constraints generally only allow for a display on two, or even a maximum of four, columns. Furthermore, since it is necessary to access several pages to collect together the useful information, this leads to tedious and lengthy head-down operations navigating between pages. A captain then has to give him or herself up to a tedious and time-consuming hassle by switching manually between the display of the different screens specific to the different waypoints of the flight plan considered. Furthermore, these head-down operations, if too frequent, can provoke among the captains a momentary loss of the flight situation (situation awareness) which is precisely a part of the captain's prime mission: to control at all times the flight situation and fly the aeroplane in total safety.

Moreover, the absence of summary information requires the captain to memorize the information from several pages to be able to have a snapshot of the aeroplane situation on a given point or procedure. He or she is forced to determine, mentally or using remote computation devices, the potential implications of notifications of constraints on a given waypoint, with respect to the other waypoints of the flight plan. This tends to significantly increase the workload of the captain.

Thus, a crew frequently has to change pages, memorize and mentally summarize an operational situation while necessarily remaining as often as possible in a determined display configuration.

Hitherto, in particular for the FMS systems, the solutions for mitigating these problems consisted in displaying a different page on each of the onboard interfaces of the aeroplane. The first page gives an overview of the flight plan and of the predictions, and it becomes necessary to do the insertion of a constraint at a point on another page and therefore on another interface whose function must normally be to display a page necessary to the following of the current flight procedure, such as, for example, the well known “PROGRESS” page.

A number of enhancements have, however, been proposed.

The U.S. Pat. No. 6,542,796 by Gibbs et al. proposes a mechanism for “vertically folding/unfolding” procedures or flight phases on the “flight plan” page. Information already present on the “flight plan” page is concatenated in two or three lines corresponding to the point towards which the aeroplane is currently heading and to the last point of the procedure concerned.

The patent FR2910678 from the same applicant proposes a vertical folding variant on several levels.

However, these solutions do not address the dual need to apprehend a current and future situation of the flight in a summary fashion, without constantly changing pages, since they only concatenate information that already exists from a well known page which is the “flight plan” page of the FMS, and to reduce the number of lines of a page in particular.

There is thus the need for a solution which makes it possible to obtain all the information useful to a flight mission to keep it available for display on a single page.

The present invention addresses this need.

### SUMMARY OF THE INVENTION

Advantageously, the invention makes it possible to determine relevant sets of information to be grouped together, in order to be able, during a mission, to display, for all the waypoints of a flight plan, either a summary grouping together all the predictions on the route, or the detail of the parameters corresponding to a type of data such as a prediction accompanied by limits, constraints or even performance levels at each of the route points.

Another object of the present invention is to offer a summarizer of information correlated by data types for each flight plan and to make it possible to view the relevant information on a single summary page of a navigation system, according to the situation and the demands of a crew.

Advantageously, the device of the invention will make it possible to reinforce the summary vision of a flight as well as the effectiveness of the captains in the planning and the short-, medium- and long-term monitoring of their flight. Thus, the safety of the flight is reinforced and savings are made by changes of flight level or redirections avoiding detours.

Thus, advantageously, the present invention makes it possible to display, side by side in order to compare them rapidly, for each of the points of a displayed flight plan, time data (UTC absolute time, minimum time performance ETAmin, maximum time performance ETAmax, minimum time constraint RTAinf, maximum time constraint RTAsup) or altitude data (predicted altitude, reachable minimum altitude, reachable maximum altitude, minimum altitude constraint limit, maximum altitude constraint limit, optimum altitude, reference altitude) or speed data (predicted speed, minimum speed Vmin, maximum speed Vmax, the speed constraint with its direction (of at or below type and being able to be visually embodied for example by the “≦” sign, or of at type and being able to be visually embodied by the “=” sign, or of at or above type and being able to be embodied by the “≧” sign), the optimum speed, the reference speed) or the navigation performance data known as Required Navigation Performance RNP, Predictive Receiver Autonomous Integrity Monitoring PRAIM, Figure of Merit FOM, Actual Navigation Performance ANP or Estimated Position Uncertainty EPU, lateral Cross Track Error XTK, Vertical Required Navigation Performance VRNP, reduced Vertical Separation Minima RVSM, altitude error, or for the important points of the flight plan such as, for example, the points known as “FROM, Top of Climb, Top of Descent, Destination”, the time and fuel data for each of the flight plans (active, temporary, secondary, datalink, reference flight plan filed by the airline AOC, etc).

Advantageously, the device presented makes it possible to display the flight data ergonomically and intuitively in order to facilitate the verification of the data and the execution of the mission by arranging the columns of data in an order which has operational sense. In particular, the current or predicted value of the information (for example the predicted altitude) is presented as central value, then directly on either side of the lower (on the left for example) and upper (on the right for example) constraints, then, immediately after the minimum (on the left for example) and maximum (on the right for example) performance levels or safety limitations of the aircraft. Furthermore, a choice is left to the user to choose the type of limitation datum by selecting it in a limited list at the column heading level. Advantageously, for the lower limit, the captain can choose from the lowest value (min), the minimum sector altitude (MSA), or the minimum enroute altitude (MEA), or the minimum off route altitude (MORA). For the upper value, the captain will be able to choose, for example, from the certified maximum altitude, the maximum altitude (function of the aeroplane weight), the optimum altitude (making it possible to best optimize a flight criterion such as the consumption or the cost of the flight).

Advantageously, the present invention can be implemented on any type of transport, whether it be in the context of the aeronautical, automobile or rail or sea transport industry.

To obtain the results sought, a method, a device and a computer program product are described.

In particular, a method implemented by computer to supply, on a human-machine interface, data relating to a flight plan for each of the points of the flight plan, comprises the steps of:
detecting a request to display points of a flight plan;
identifying the individual data in the request, and creating links between the identified individual data;
calculating the situation of the flight and generating a consolidated flight situation;
associating the linked individual data with the consolidated flight situation in order to extract therefrom updated situational data;
formatting the situational data generated to allow for a summary or detailed display of said data according to the human-machine interface; and
displaying, at each point on a single flight plan page of the human-machine interface, the situational data in an order that makes it possible to visually bound a predicted value by at least the possible lower and upper constraints and the minimum and maximum performance levels or safety limitations of the aircraft.

Advantageously, the method makes it possible when displaying to choose, for the lower limits, from the lowest value (MIN), the minimum sector altitude (MSA), the minimum enroute altitude (MEA), the minimum off route altitude (MORA), and, for the upper limits, from the certified maximum altitude, the maximum altitude, or the optimum altitude.

Advantageously, the method allows for a limit value or constraint value to be displayed according to a specific colour when it is reached and infringed by the current predicted value of the datum.

Advantageously, the method further comprises, after the display step, the steps of:
modifying the situation of the flight plan; and
computing the new situation of the modified flight plan.

Advantageously, the step of creating links between the identified individual data comprises the step of using predefined groupings of data stored in a database (REG).

Advantageously, the database is modifiable dynamically, and can be a module incorporated in a flight management system or else an embedded external module operationally coupled to a flight management system.

Advantageously, the step of creating links comprises the creation of links according to classes of data defined for predicted data limits data, constraint data or optimal data.

Advantageously, the step of creating links comprises the creation of links according to types of data defined for altitude, speed, time, navigation accuracy or remaining fuel data.

Advantageously, the data summarized on the flight plan page are displayed in a defined order and number of columns.

Advantageously, the detailed display of the data makes it possible to replace at least one column of the summary display with a plurality of columns containing detailed data, the display of the plurality of columns being optimized according to the human-machine interface.

Advantageously, the detailed display of the data can be adapted dynamically to reverse the order and/or modify the number of columns displayed.

Advantageously, the data summarized on the flight plan page can be grouped together in lines according to the type of decision point.

Advantageously, the device for supplying, on a human-machine interface, data relating to a flight plan, for all the points of the flight plan, comprises means for implementing the steps of the method, in particular means for entering a request to display data of the flight plan and means for modifying the display of the data.

Advantageously, the device of the invention can be implemented in a flight management aid system coupled to a human-machine interface.

The method of the invention can be implemented in the form of a computer program product comprising code instructions making it possible to perform the steps of the method, when said program is run on a computer.

### BRIEF DESCRIPTION OF THE DRAWINGS

Different aspects and advantages of the invention will emerge supporting the description of a preferred embodiment but nonlimiting implementation of the invention, with reference to the figures below:

FIG. 1 shows the structure of a flight management system of FMS type, known from the prior art;

FIG. 2 shows an exemplary display of a “flight plan” page according to a known human-machine interface;

FIG. 3 shows another exemplary display of a “flight plan” page;

FIG. 4 is a flow diagram illustrating a method for summarizing flight plan information according to the present invention;

FIGS. 5a and 5b show an exemplary display of an “FPLN” page according to a first embodiment of the invention;

FIG. 6 shows an exemplary display of an “FPLN” page according to a second embodiment of the invention;

FIG. 7 shows an exemplary display of an “FPLN” page according to a third embodiment of the invention;

FIGS. 8a and 8b show an exemplary switch from a folded “FPLN” page to an unfolded “FPLN/SPD” page according to the principles of the invention;

FIGS. 9a and 9b show an exemplary switch from a folded “FPLN” page to an unfolded “FPLN/ALT” page according to the principles of the invention;

FIGS. 9c and 9d respectively show an exemplary choice of minimum or maximum value;

FIG. 10 shows an example of an unfolded “FPLN/NAV ACCUR” page according to the principles of the invention;

FIGS. 11a and 11b shown an example of an “FPLN” page with “flight plans” tab and delta display according to the principles of the invention;

FIG. 12 shows an example of an “FPLN” page with delta display of the impacts of the speed strategies according to the principles of the invention;

FIGS. 13a and 13b show an exemplary switch from an “FPLN” page with display of the decision points folded to an unfolded page according to the principles of the invention.

### DETAILED DESCRIPTION

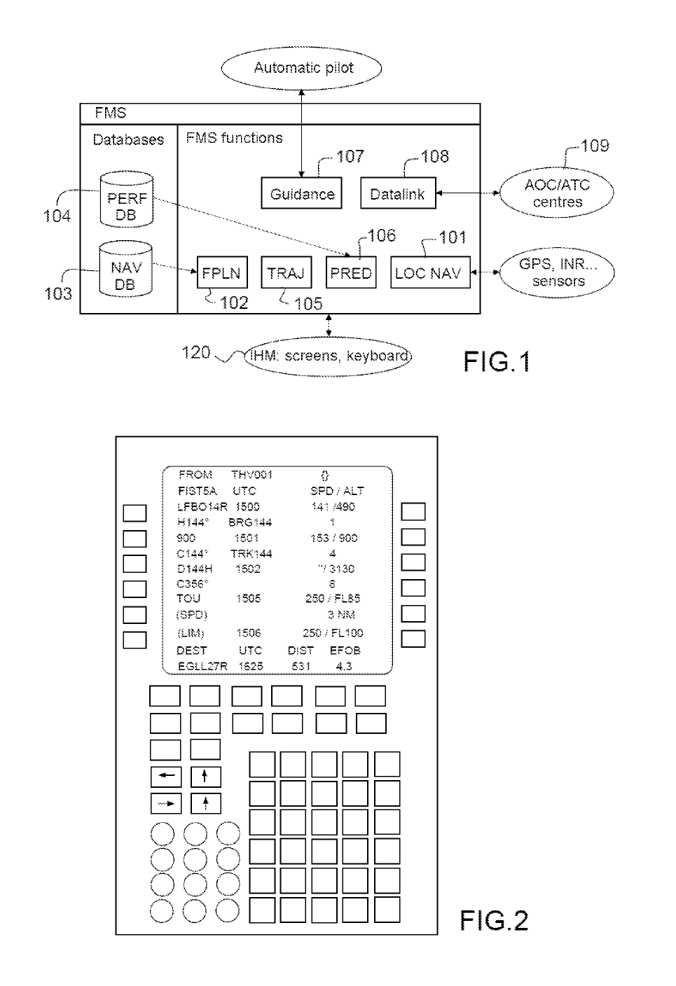

FIG. 1 shows an example of the functional modules of a flight management system 100 in a preferential but nonlimiting implementation of the invention and enables a person skilled in the art to implement variants.

The system 100 has a human-machine interface 120 comprising input means, for example formed by a keyboard, and display means, for example formed by a display screen, or else simply a touch display screen, as well as at least the following functions, described in the ARINC 702 standard, “Advanced Flight Management Computer System”, dated December 1996:
navigation (LOCNAV) 101, for performing optimal location of the aircraft as a function of the geolocation means 130 such as geopositioning by satellite or GPS, GALILEO, VHF radio navigation beacons, inertial platforms. This module communicates with the abovementioned geolocation devices;
flight plan (FPLN) 102, for inputting the geographical elements constituting the skeleton of the route to be followed, such as the points imposed by the departure and arrival procedures, the waypoints, the air corridors, commonly called “airways”;
navigation database (NAVDB) 103, for formulating geographical routes and procedures with the help of data included in the bases relating to the points, beacons, interception or altitude legs, etc.;
performance database, (PERFDB) 104, containing the aircraft's aerodynamic and engine parameters;
lateral trajectory (TRAJ) 105, for formulating a continuous trajectory on the basis of the points of the flight plan, complying with the performance levels of the aircraft and the confinement constraints (RNP);
predictions (PRED) 106, for formulating an optimized vertical profile on the lateral and vertical trajectory and giving distance, time, altitude, speed, fuel and wind estimations notably on each point, at each change of piloting parameter and at destination, which will be displayed to the crew;
guidance (GUID) 107, for guiding in the lateral and vertical planes the aircraft on its three-dimensional trajectory, while optimizing its speed, using information computed by the prediction function 106. In an aircraft equipped with an automatic piloting device 110, the latter can exchange information with the guidance module 107;
digital datalink (DATALINK) 108 for exchanging flight information between the flight plan/prediction functions and the control centres or other aircraft 109.

From the flight plan defined by the captain and the list of waypoints and of procedures (departure, arrivals, airways, missions), the trajectory is computed as a function of the geometry between the waypoints (commonly called LEG) and/or the altitude and speed conditions which are used to compute the turn radius. On this lateral trajectory, the FMS optimizes a vertical trajectory, passing through any altitude, speed, time constraints.

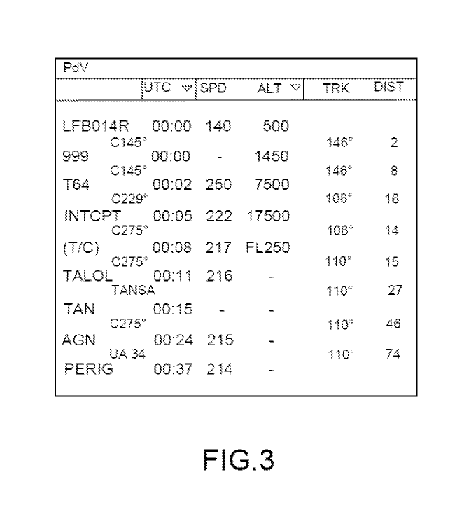

All of the information entered or computed by the FMS is grouped together on pages. FIGS. 2 and 3 illustrate exemplary displays of a “flight plan” page according to known human-machine interfaces. The existing systems make it possible to navigate from page to page, but the size of the screens which, depending on the technologies, make it possible to display between 6 and 20 lines and between 4 and 6 columns, do not meet the need to apprehend a current and future situation of the flight in a summary fashion. During the execution of a mission, the flight plan page (“PdV” in FIG. 3) contains the route information followed by the aeroplane such as the list of next waypoints with their associated distance, time, altitude, speed, fuel, wind predictions.

Similarly, the “performance levels (PERF)” or “flight progress” page contains the parameters that are useful for guiding the aeroplane over the short term such as the speed to be followed, the altitude ceilings, the next changes of altitude.

The other typical pages available on board are:
The group of lateral and vertical revision pages, which comprise the following pages:
   “initialization” for initializing a route and its main parameters
   “departure” for inputting the departure procedures
   “arrival” for inputting the arrival procedures
   “airways” for inputting the list of the airways
   “alternate” for inputting and checking the information on alternate airports
   temporary and secondary flight plans
   “DIR TO” to perform a DIRECT TO to a waypoint
   for inputting vertical constraints (altitude, speed, time)
   “HOLD” for inputting the holding patterns
   “Meteo” for inputting wind and temperature information during the different flight phases
The group of information pages which comprise the following pages:
   “Data” for displaying data linked to elements of the ARINC 424 navigation database: one page for the stored routes, one page for the “waypoints”, on page for the “radio beacons”, one page for the “airports”
   “Status” which give the configuration of the aeroplane (part number of the software and databases, etc.). There may be ten or so pages of this type.
   “location” which make it possible to know the positioning of the aeroplane with the different sensors, navigation accuracy, the beacons used for navigation, etc.
   “weight management” which make it possible to input and check the weights (weight empty, fuel on board) and the centre of gravity
   “route summary” which make it possible to display a summary of the route or of the mission.

There are also, depending on the types of aircraft, other additional pages.

Thus, since the totality of the screens is monopolized by two pages containing a small number of columns, the useful and relevant information of the other pages is not visible.

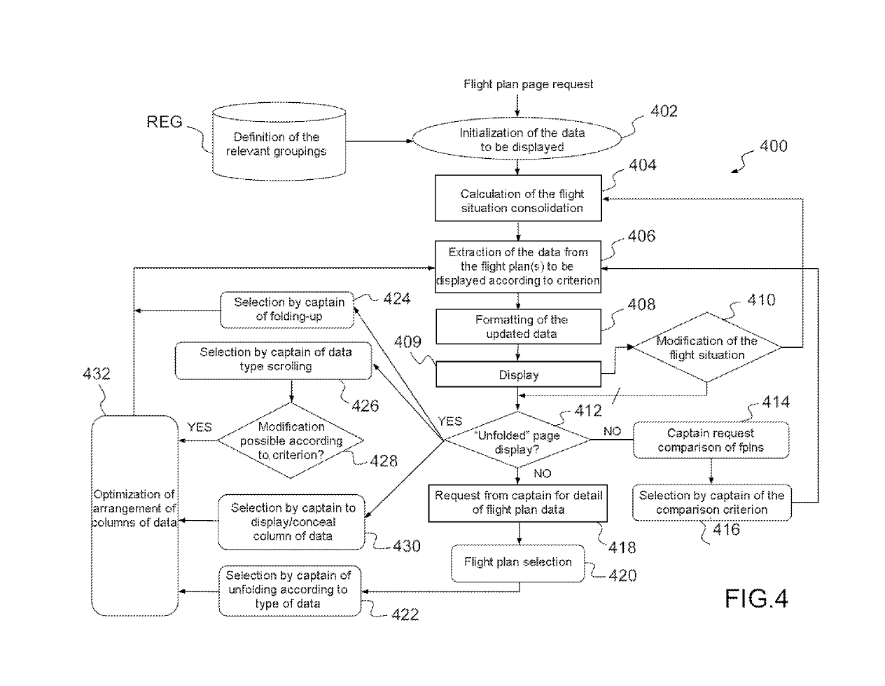

FIG. 4 shows the steps applied by the method of the invention to summarize the flight plan information in a preferential implementation of the invention. Generally, the method 400 makes it possible to establish relevant groupings of information as a function of the flight situation and to summarize the display of the data in a grouped mode and in an ungrouped mode. The grouped display offers a summary of the situation, whereas the ungrouped display offers a more accurate detail of the situation, in particular showing the predictions in relation to a type of constraint (for example, the speed predictions in relation to the values and types of speed constraints and with the optimum speed, the reference speed or any other previously entered speed).

The relevant groupings are defined and stored in an elementary information database (REG). This base can be statically defined or dynamically modified, and can be stored on board the aircraft as a module of the flight management system (100) or be kept on the ground. The base comprises the various data which are displayed on the different pages of the FMS and the “individual or elementary” data which exist in the state of the art of the FMS, such as:
Point name
Name of the air route or procedure
Distance to the next point
Route angle (track) to the next point
Required horizontal navigation precision (RNP), required vertical navigation precision (VRNP/RVSM)
Predicted horizontal navigation precision (EPU or Estimated Navigation Performance)
Altitude, speed, time (UTC), wind, fuel prediction
Altitude constraints (min and max limits), speed constraints (min and max limits), time constraints (min and max limits), slope constraints
Status of the altitude constraints (“missed”, “made”, “ignored”), status of the speed constraints (“missed”, “made”, “ignored”), status of the time constraints (“missed”, “made”, “ignored”)
ATC instructions
Maximum and minimum flight speeds
Altitude ceiling (max altitude)
Minimum safety altitude (MORA)
Earliest and latest arrival times
Optimum altitude, optimum speed.

To proceed with the grouping of the data, the latter are typed. They can be typed by their unit, which can be the altitude or the speed or the time for example, or alternatively by other parameters such as a typing by data class such as the class of constraints, or the class of predictions or for example the class of optimizations. A person skilled in the art will appreciate that only a few examples of typing are indicated but are in no way limiting on the possible groupings.

To return to FIG. 4, when a request for a “flight plan” page is detected, the method, in a step 402, proceeds to initialise the data which will have to be displayed. Links between the elementary data are created.

The links can be established from classes of the data. In a preferential implementation, six classes are defined:
Class C1 for the predicted data: predicted altitude, predicted speed, predicted time, predicted wind, predicted fuel
Class C2 for the ATC constraints of the flight plan: altitude, speed, time constraints, ATC instructions (i.e. from air traffic control)
Class C3 for the aeroplane structural constraints: minimum and maximum flight speeds, altitude ceiling, earliest and latest arrival times
Class C4 for the optimum data with respect to criteria: optimum altitude, optimum speed
Class C5 for the prediction data for the operational choices: predicted time, predicted fuel, predicted altitude
Class C6 for the airline operational constraints: fuel constraints, criterion for optimizing the flight by phase or by segment, commonly known as “flight criteria” or “cost index”.

Alternatively, in another implementation, the links between the data can be established from data units. In a preferential implementation, seven data units are defined:
Unit D1 for the altitude data: predicted altitude, altitude constraints, altitude ceiling, optimum flight altitudes (from the viewpoint of an optimization criterion such as fuel for example), minimum flight altitudes (safety altitudes with respect to the relief such as MORA, MSA, etc.), ATC altitude instructions
Unit D2 for the time data: predicted time, time constraint, earliest time of arrival, latest time of arrival, ATC time instructions
Unit D3 for the speed data: predicted speed, speed constraint, optimum speeds, minimum flight speed, maximum flight speed, ATC speed instructions
Unit D4 for the characteristic flight data: departure airports, top of climb, top of descent, arrival airport
Unit D5 for the different flight plans: active, temporary, secondary, ATC, AOC
Unit D6 for the fuel data: predicted fuel, minimum reserves, maximum fuel on arrival, minimum fuel on arrival, optimum fuel with respect to the airline criterion
Unit D7 for the navigation accuracy data: RNP, EPU/ANP, VRNP, RVSM, etc.

Thus, the initialization step 402 makes it possible to generate a database of linked objects.

In the next step 404, the method identifies the parameters of the flight situation. The flight situation will be understood by those skilled in the art to be the environment in which the aeroplane is situated at a given moment.

Firstly, the elementary situations are determined. They consist in determining:
The flight phase: on the ground before take-off (taxiing), taking off, climbing, cruising, descending, approaching the destination, on the ground at destination, go-around
The weather situation: short-term problem (weather radar), medium term problem (AOC, ATC uplink), reception of new wind map, areas to be avoided (eruptions, etc.)
The situation with the aeroplane systems: system failures detected, limitations of the communication or monitoring systems, problems influencing the fuel (leak, engine problem, depressurization, landing gear lowered, flaps extended)
The ATC situation: diversion negotiation, flight level or flight speed negotiation
The airline situation (AOC): behind/ahead of schedule, problem on board (passenger sick, etc.) requiring a diversion, route/fuel optimization criterion
The surrounding traffic/relief situation: diversion in mountainous region, dense traffic
The operational situation: crew turnover, ETOPS flight, etc.

Once the elementary situations are determined, an aeroplane situation consolidation phase is applied. This step can, for example, order the priorities of the elementary situations (“>” being able to signify “higher priority than”):
Aeroplane systems situation>traffic/relief situation>weather situation>ATC situation>operational situation>airline situation>flight phase situation.

In this approach, if there is no aeroplane system failure, no traffic/relief problem, no weather problem, but an ATC negotiation in progress, the consolidated situation will be “ATC situation”.

In a variant implementation, the consolidated situation can consist in combining elementary situations.

Preferentially, the consolidation can give a consolidated situation on take-off (take-off flight phase) which predominates over the other situations except over the aeroplane system situation. Then, when cruising, the priority reverts to the ATC situation, and, in descent or approach, the traffic/relief situation may become predominant. Thus, the step 404 generates a consolidated aeroplane situation.

The next step 406 consists in extracting the data to be displayed. The method will associate the data from the database generated in the step 402 with the situation defined in the step 404. Thus, for a given consolidated aeroplane situation, the method extracts the most relevant linked data batches.

As an example, for an “ATC situation” aeroplane situation, the data of the unit D4 will be extracted and filtered on the class C4 data as a function of the data from the unit D5, that is to say the predicted data (altitude, time, fuel) corresponding to the characteristic points (airports, top of climb, top of descent), as a function of the different flight plans.

Advantageously, in a climbing, cruising or descending “flight phase” aeroplane situation, the method extracts respectively the data from the units D1, D2 and D3, as a function of the data from the unit D5.

Advantageously, in an “AOC situation” aeroplane situation, the method extracts the data from the unit D2 as a function of the data from the unit D5, that is to say the time data along the flight plan.

Still advantageously, in a “traffic/relief situation” aeroplane situation, the method extracts the data from the unit D1 as a function of the data from the unit D5.

Advantageously, in a “system failure” situation, the method extracts the data from the units D1 and D6 as a function of the data from the unit D5.

A person skilled in the art will understand that only a few relevant data extraction examples have been cited, but that the method makes it possible to extract the appropriate data from the units and classes as a function of the situations defined in the preceding step.

In the next step 408, the method formats the extracted situational data to allow, in a subsequent step (409) for a summary display (masked/folded) or detailed display (visible/unfolded) of the data depending on the choice of the captain such that the situational data generated on a screen of the human-machine interface is in an order that makes it possible to visually bound a predicted value with any lower and upper constraints, and the minimum and maximum performance levels or safety limitation of the aircraft.

Thus, the choice can be made on one page, and the captain can select the display of the corresponding data. These data have been determined according to their mutual connections: thus, it is relevant to group together the data of the same class or of the same type for the display.

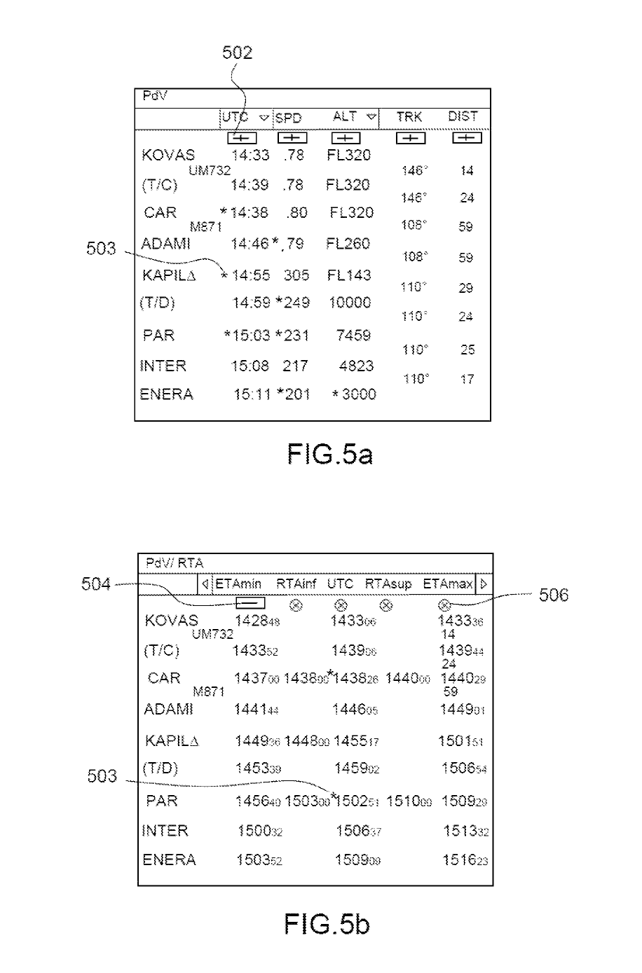

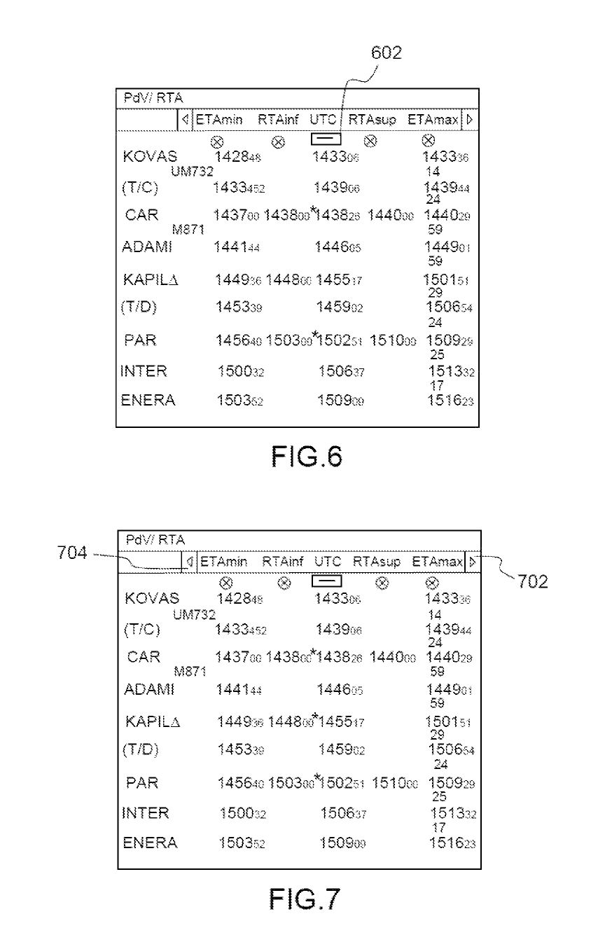

For the time data, the unfolded display enables the crew to obtain the operational situation of the flight in relation:
to the time constraints defined on the flight plan—be it ahead, behind or on time—indicated by the RTAinf and RTAsup columns of FIG. 5b;
to the operational capabilities of the aeroplane—what are the earliest and latest possible times of arrival on a given point—displayed in columns ETAmin and ETAmax of FIG. 5b.

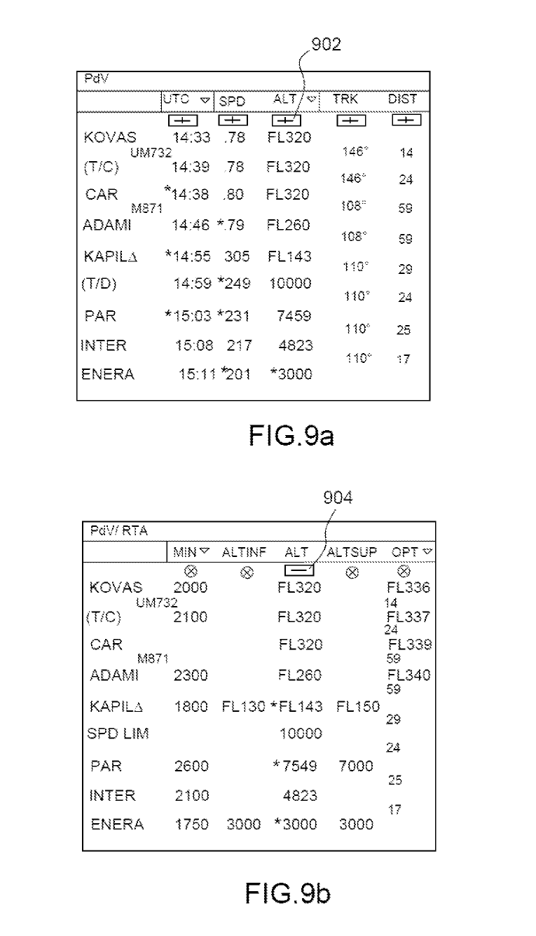

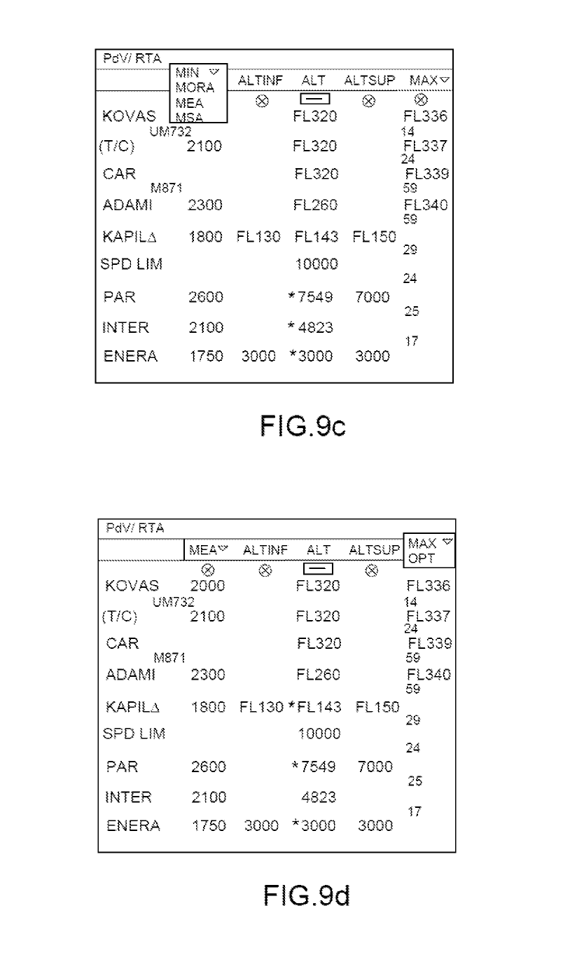

For the altitude data, the unfolded display enables the crew to obtain the operational situation of the flight in relation:
to the altitude constraints defined on the flight plan—will it observe these constraints—indicated by the ALTinf and ALTsup columns of FIG. 9b;
to the ceilings linked to the relief: MORA, the acronym standing for “Minimum Off Route Altitude”, of FIG. 9b. In the terminal phase (close to the airports), the MORA can be replaced by the MSA, the acronym standing for “Minimum Safe Altitude”, which defines the safe altitude to be observed on arrival in an airport area, as a function of the heading of arrival;
to the operational capabilities of the aeroplane: what are the most interesting flight levels? indicated by the OPT column of FIG. 9b. It would also be possible to display the maximum ceilings reachable at any point of the flight.

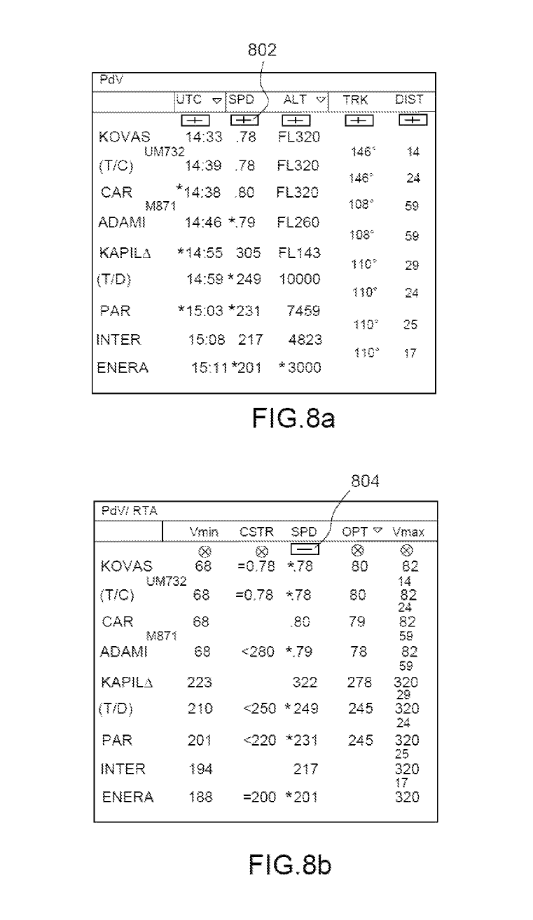

For the speed data, the unfolded display enables the crew to obtain the operational situation of the flight in relation:
to the speed constraints defined on the flight plan—will it observe these constraints—indicated by the CSTR column of FIG. 8b;
to the operational capabilities of the aeroplane: what are the most interesting flight speeds? (indicated by the OPT column of FIG. 8b) and what are the minimum and maximum speeds achievable given the flight envelope of the aeroplane? (indicated by the Vmin and Vmax columns of FIG. 8b).

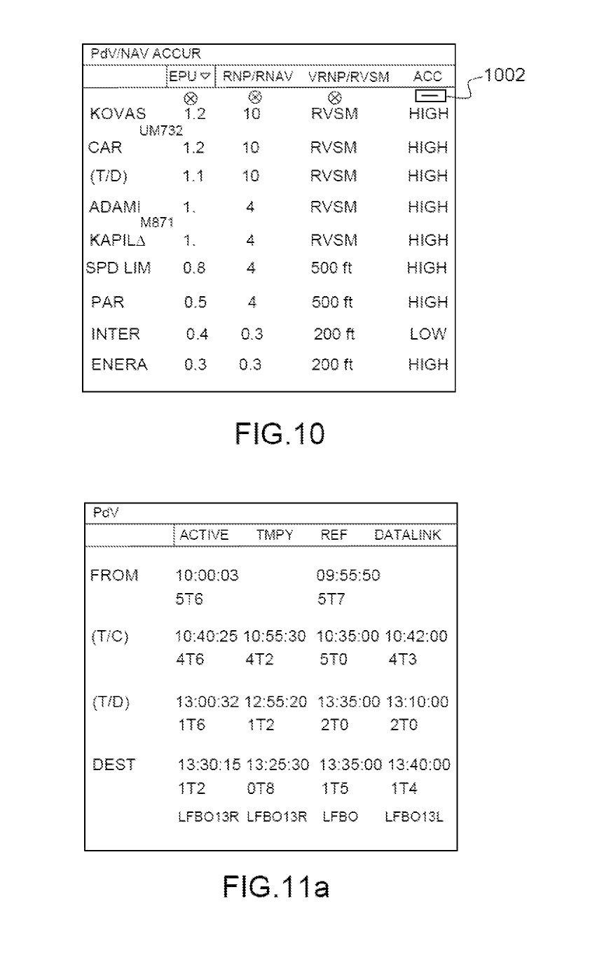

For the navigation performance data, the unfolded display enables the crew to obtain the operational situation of the flight, indicated by the EPU column which gives the lateral navigation performance on FIG. 10, and the ACC column (accuracy) column which gives the accuracy obtained on this same figure in relation:
to the regulatory constraints defined on the flight plan, indicated by the RNP/RNAV column of FIG. 10 for the lateral constraints and the VRNP column of this same figure for the vertical constraints.

Thus, for all these data (time, altitude, speeds, navigation performance), the method makes it possible to display (409) the data in an operationally relevant order, namely: display the predicted data at the centre, display the constraints on either side (left/right) of the predicted datum, then display the operational capabilities of the aeroplane on either side (left/right) around the constraints. At the lateral ends of the page, the method displays the optimums when they are defined. The order in question can be chosen differently in another implementation, and modified either by the captain, or by changing the order of the columns in the link database.

When the aeroplane context changes, some of the non-relevant data may no longer be displayed.

Thus, the method can advantageously filter to no longer display the following:
the “OPT” fields (FIG. 9) in the predicted climb and descent phase (i.e. before the top of climb point (T/C) and after the top of descent point (T/D)), because they have operational meaning only in the cruising phase;
the “max” fields (FIG. 9) in the predicted descent phase (i.e. after the top of descent point (T/D)), because the maximum altitudes have a meaning when climbing (climb and cruising phases);
the “MEA” (Minimum Enroute Altitude, FIG. 9) fields in predicted climb phase (i.e. before the top of climb point (T/C)), and only when the navigation mode is LNAV (lateral navigation, or navigation mode slaved along the flight plan) because the “En Route” (i.e. along the flight plan) safe minimum altitudes have a meaning only for the cruising and descent phases, in guidance along the flight plan mode;
the “MORA” (Minimum Off Route Altitude, FIG. 9) fields when the navigation mode is not LNAV (lateral navigation, or navigation mode enslaved along the flight plan) because the “Off Route” safe minimum altitudes (i.e. outside the flight plan) have a meaning only when the flight plan is not being followed;
the “MSA” Minimum Sector Altitude, FIG. 9) fields when the flight phase is cruising (i.e. between the (T/C) and the (T/D)) because they have meaning only in proximity to the departure and arrival airports.

In addition, the method proposes a minimum altitude choice called “MIN” which displays the minimum of the above altitudes (MORA, MEA, MSA).

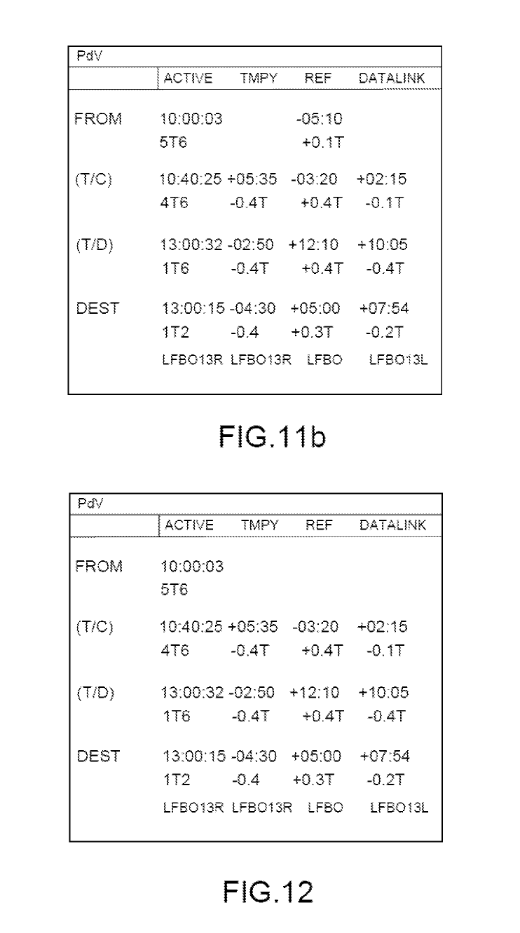

For the flight plan data, the unfolded display enables the crew to obtain the operational situation of an executed flight plan, indicated by the “ACTIVE” column of FIG. 11a, in relation:
to a current modification in a temporary flight plan, indicated by the TMPY column of FIG. 11a;
to the reference flight plan as filed initially by the airline (AOC) or air traffic control (ATC), indicated by the REF column of FIG. 11a;
to an instruction from air traffic control, which gives rise to a “Datalink” flight plan of FIG. 11a.

The relevant comparisons are the fuel and the time of arrival at the destination, and at the major intermediate points of the flight (top of climb, top of descent). The invention makes it possible to compare the “absolute” data or in relative mode in relation to one of the chosen flight plans, shown in FIG. 11b.

The unfolding can also make it possible to compare data for a chosen flight plan (for example the ACTIVE which is the executed flight plan) according to the different flight strategies. Thus, it is possible to compare a number of speed strategies which have an operational meaning:
the “DESELECT” strategy of FIG. 12 making it possible to anticipate the future operational situation if the tactical speed mode is left at the next speed constraint point;
the “PHASE” strategy of FIG. 12 making it possible to anticipate the future operational situation if the tactical speed mode is left during the next flight phase, the phases being take-off, climb, cruising, descent, approach, go-around; and
the “PHASE” strategy of FIG. 12 making it possible to anticipate the future operational situation if the tactical speed mode is left at the end of the instruction predicted by air traffic control.

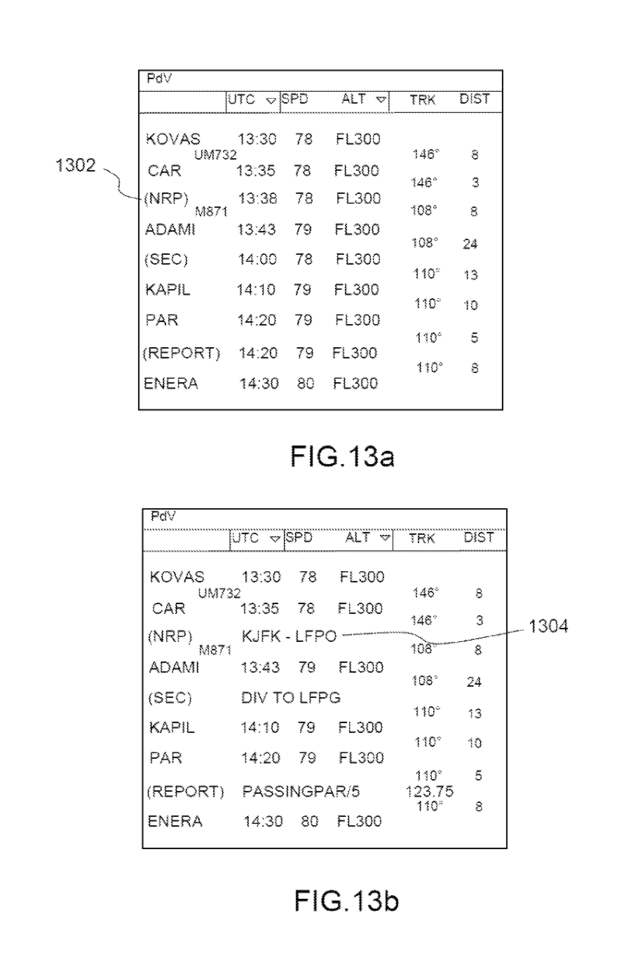

Finally, the unfolding can also make it possible to compare different alternatives at operational decision points, in relation to a flight plan, such as, for example, in relation to the ACTIVE which is the executed flight plan:
decision point for changing from one flight plan to another flight plan, indicated for example by the “(SEC)” parameter of FIG. 13b;
non-return point (or equitime point) from which there must no longer be any return, indicated for example by the “(NRP)” parameter (1304) of FIG. 13b;
point of diversion to an alternate airport (not shown on the figures);
point at which an action must be taken by the crew, indicated for example by the “(REPORT)” parameter in FIG. 13b to call back to air traffic control.

Advantageously, the choice can be made on a detailed display of the time (UTC) with the unit D2 data displayed. Alternatively, in folded mode, only the predicted time of the data class C1 is displayed on the page. An example is shown in FIGS. 5a and 5b.

As illustrated in FIG. 5a, the possible unfolding is indicated by an expansion tab (502) (“widget”). The captain obtains the display of the data by clicking on the “+” widget and advantageously obtains a display on the same screen as shown in FIG. 5b. The folding is obtained by clicking on a reduction tab (504) which replaces the preceding “+” widget so as to allow unfolding/folding to be toggled by two successive strokes on the same key, thus avoiding having to move and reposition the cursor or the index on another position. Advantageously, the invention allows for a choice of different colours of a constraint for the display corresponding to the type of the datum which is satisfied (according to one colour), unsatisfied (according to another colour), or ignored (according to a third colour).

Alternatively, in the case of a touch screen, the unfolding/folding action uses the functionalities of the touch screen, multi-touch or “single click” or “double click” of the finger on the widget concerned, or even, depending on the technology, a multi-touch gesture of thumb-index finger separation motion type on the widget.

In this example linked to the time data, the “unfolded” columns are arranged with the “UTC” reference column at the centre with the RTAinf and RTAsup constraint limits immediately then to the left and to the right and finally, in the columns at the ends, the ETAmin and ETAmax capabilities. The relevant information is advantageously presented in colour and a visual sign (503) can be attached in order to be more easily identifiable visually by the captain.

Advantageously, the number of columns can be reduced if the captain estimates that he or she does not need them by clicking on a \textcircled{x} sign situated under each column (except the reference column) as indicated in (506). The placement of the remaining columns is then redistributed in order to keep them alongside one another. The vacant column is then replaced by the one judged the most relevant according to the aeroplane situation.

Still advantageously, the choice of the captain can be made on a detailed display of the speeds with the unit D3 data displayed. Alternatively, in folded mode, only the predicted speed of the data class C1 is displayed on the page. An example is shown in FIG. 8a (802) and 8b (804). Advantageously, a limit value, when it is reached and infringed by the predicted current value of the datum, is displayed according to a specific colour.

As shown in FIGS. 9a (902) and 9b (904), a detailed display can be requested for the altitudes with the unit D1 data displayed. Alternatively, in masked or deselection mode, only the predicted altitude of the data class C1 is displayed on the page.

FIGS. 9c and 9d respectively illustrate an exemplary display of minimum or maximum values.

FIG. 10 illustrates the display of a page for a grouping and extraction of data on the navigation accuracy information.

In another option, a detailed display for comparison of the flight plan with the class C4 and unit D4 data filtered as a function of D5 can be displayed as illustrated in FIGS. 11a, 11b. It should be borne in mind that the comparisons between flight plan are made in relation to a reference flight plan selected by the captain.

FIG. 12 illustrates an extraction of data for a comparison of speeds resulting in a delta mode display of the impacts of the speed strategies.

FIGS. 13a and 13b illustrate an extraction of data on a grouping according to the types of decision points for a comparison between different flight alternatives resulting in a masked display (1302) of the decision points in FIG. 13a and an unfolded display (1304) of the decision points in FIG. 13b.

Returning to FIG. 4, the method can incorporate a step 410 for taking into account possible modifications of the flight situation. In this step, a check on the elementary situations is performed, and in particular on:
A change of flight phase
A modification of the weather Situation (reception of a wind map, detection of a weather event on the weather radar, etc.)
A modification of the aeroplane systems Situation: detection of a failure of the systems
A modification of the ATC Situation: reception of a clearance by datalink
A modification of the airline Situation (AOC): reception by datalink of airline information (delays, change of flight plan, etc.)
A modification of the surrounding traffic/relief Situation: detection of short-term or medium-term conflict with the terrain or traffic.

If one or more modifications are detected, the method loops back to the step 404 to perform a new computation of the flight situation.

Otherwise, the method enters into a sequence of operations (412 to 432) of the unfolded/folded modes of display of flight pages as a function of the requests from the captain.

If, in the step 412, the page is not unfolded, the method enables the captain to perform a request (414) for comparison of FPLN flight pages, then to select the comparison criteria (416). The method extracts the data corresponding to the comparison request (step 406), and allows for the display of the situational data obtained (step 408).

Similarly, if, in the step 412, the page is not unfolded, the method enables the captain to perform a request (418) for detail of the flight plan data, to select the flight plan (420) and to choose the pages to be unfolded (422). Depending on the choices made, the method makes it possible to organize the data for an optimized display (432).

If, in the step 412, the page is in unfolded mode, the method enables the captain to make a selection for folding (424) or scrolling of the data (426) or else for display of data columns (430).

In the case of a data scrolling selection, the method makes it possible to indicate a modification according to certain criteria (428).

After the steps 424, 428, 430, the method makes it possible to organize the data for an optimized display (432).

After the step 432, the method returns to the step 406.

Advantageously, the display of the data can be adapted and presented in multiple variants, such as, for example:
The number and the order of the columns displayed in the unfolded state is predetermined but can be modified at any instant by the captain:
   The number of columns can be reduced if the captain estimates that he or she no longer needs them by clicking on an appropriate reduction tab. The placement of the remaining columns is then redistributed in order to keep them alongside one another. The vacant column is then replaced by the one judged most relevant according to the aeroplane situation.
   The order of the columns can also at any time be adapted to the wishes and needs of the captains by dragging/dropping the label of the column at the desired position.
When the lateral unfolding does not occupy all of the available columns, the method makes it possible to determine, from the remaining columns the information that is most relevant to be displayed. Typically, if the captain wants to only display ETAmin/ETAmax and ETA on the flight plan page of FIG. 5b, there then remains two available columns, and the method can determine, for example, depending on the aeroplane situation, that the most relevant information to be displayed is a priority ALT/SPEED.
When the lateral unfolding requires more columns than those available on the page, indicators are added on one side and the other of the columns in view in order to suggest to the captain that he or she can have additional information by clicking on one or other of the arrows. An example is shown in FIG. 7 by the arrows (702, 704).

In variants of implementation, the lateral scrolling by means of the arrows can behave either:
in open loop mode: the last column on each side behaves as an end stop which renders the corresponding arrow inactive, or
in closed loop mode: when the necessary number of columns exceeds the number of columns that can be displayed on the page, the left and right arrows are active and allow for the lateral scrolling of the columns.

Advantageously, the method can allow for a rotation of the displays of the lateral data (TRK/DIST) with “ALT/SPEED”.

Still advantageously, the method makes it possible to use the hyperlink technology (for example of HTML type) to access an element.

Thus, the present description illustrates a preferential implementation of the invention, but is not limiting. Examples have been chosen to allow for a good understanding of principles of the invention, and a concrete application, but are in no way exhaustive and should enable a person skilled in the art to add modifications and implementation variants by keeping to the same principles.

The present invention can be implemented from hardware and/or software elements. It can be available as a computer program product on a computer-readable medium. The medium can be electronic, magnetic, optical, electromagnetic or be a broadcasting medium of infrared type. Such media are, for example, semiconductor memories (Random Access Memory RAM, Read-Only Memory ROM), tapes, diskettes or magnetic or optical disks (Compact Disk—Read Only Memory (CD-ROM), Compact Disk—Read/Write (CD-R/W) and DVD).

1. A flight management method for an aircraft for supplying, on a human-machine interface, predicted flight parameters for each of the waypoints of a flight plan, the method being implemented by computer and comprising:
identifying, from a request to display information relating to a flight plan, groups of data to be displayed for a waypoint, the groups of data corresponding to predefined groupings in the flight management system;
determining a set of parameters relating to the situation of the flight;
applying the situation parameters of the flight to the groups of data to generate contextual groups of data; and
formatting, according to the human-machine interface, the contextual groups of data to allow for a summary display of groups of data or a detailed display of the data of a group, the data of a group being displayed in an order that makes it possible to visually bound a predicted value of a datum by at least the lower and upper constraint values, performance levels or minimum and maximum safety limitations of the aircraft.

2. The method according to claim 1, in which the display makes it possible to choose, for the lower limits, from the lowest value (MIN), the minimum sector altitude (MSA), the minimum enroute altitude (MEA), or the minimum off route altitude (MORA), and, for the upper limits, from the certified maximum altitude, the maximum altitude, or the optimum altitude.

3. The method according to claim 1, in which the display makes it possible to display, side by side in order to compare them rapidly, for each of the points of a displayed flight plan, the speed constraint with its direction, i.e. of below type visually embodied by the “≦” sign, or of at type visually embodied by the “=” sign, or of at or above type embodied by the “≧” sign.

4. The method according to claim 1, in which a limit or constraint value is displayed according to a specific colour when it is reached and infringed by the current predicted value of the datum.

5. The method according to claim 1, further comprising:
modifying the situation of the flight plan; and
calculating a new situation of the modified flight plan.

6. The method according to claim 1, in which the predefined groupings of data are stored in a database of the flight management system.

7. The method according to claim 6, in which the database is modifiable dynamically.

8. The method according to claim 6, in which the database is an embedded external module operationally coupled to the flight management system.

9. The method according to claim 1, in which the groups of data group together data according to classes of data defined for predicted data limits data, constraint data or optimal data.

10. The method according to claim 1, in which the groups of data group together data according to types of data defined for altitude, speed, time, navigation accuracy or remaining fuel data.

11. The method according to claim 1, in which the data summarized on the flight plan page are displayed in a defined order and number of columns.

12. The method according to claim 11, in which the detailed display of the data makes it possible to replace at least one column of the summary display with a plurality of columns containing detailed data, the display of the plurality of columns being optimized according to the human-machine interface.

13. The method according to claim 12, in which the detailed display of the data can be adapted dynamically to reverse the order and/or modify the number of columns displayed.

14. The method according to claim 1, in which the data summarized on the flight plan page are grouped together in lines according to the type of decision point.

15. A device for supplying, on a human-machine interface, data relating to a flight plan for all the points of the flight plan, the device comprising means for implementing the method according to claim 1.

16. The device according to claim 15, in which the human-machine interface comprises means for entering a request to display data of the flight plan and means for modifying the display of the data.

17. A flight management aid system coupled to a human-machine interface, the system comprising the device according to claim 15.

18. A computer program product, said computer program comprising code instructions making it possible to perform the steps of the method according to claim 1, when said program is run on a computer.
